(19) United States
(12) Patent Application Publication
(10) Pub. No.: US 2010/0212488 A1
(43) Pub. Date: Aug. 26, 2010

(54) Hydro-Pneumatic Cylinder with Controlled Stop Position

(75) Inventors: Antonio Valor Valor, Mondragon (Gipuzkoa) (ES); Alberto Gabicagogeascoa Benito, Bilbao (Bizkaia) (ES)

Correspondence Address: Berenbaum Weinshienk PC, 370 Seventeenth Street, Republic Plaza, Suite 4800, Denver, CO, 80202, US

(73) Assignee: NITRO-GAS, S.A. Unipersonal., Vitoria-Gasteiz (Alava) (ES)

(21) Appl. No.: 12/681,346

(22) PCT Filed: Oct. 6, 2008
(86) PCT No.: PCT/EP2008/008412

§ 371 Date: Apr. 1, 2010

(30) Foreign Application Priority Data
Oct. 4, 2007 (ES) P 200702601

(51) Int. Cl. F15B 15/26

(52) U.S. Cl. 91/43

(57) ABSTRACT

A cylinder having a hollow cylindrical body with an axially moveable rod disposed therein that is moveable between a rest position and a stop position. The cylindrical body and rod are configured so as to create a main chamber located between a lower surface of the rod and a base of the cylindrical body. And to also create an auxiliary chamber that is connectable to the main chamber via a flow channel in the rod. In one implementation the main chamber is adapted to contain a gaseous fluid and an oily fluid mixture when the rod is in the rest position so that the fluid exerts a first force on the lower surface of the rod to urge the rod toward the rest position. When the rod is in the stop position the main chamber predominately contains only the oily fluid. The auxiliary chamber is in flow communication with the main chamber via the flow channel when the rod is not in the stop position, the first auxiliary chamber, main chamber and flow channel configured to cause at least the gaseous fluid to be located in the main chamber to pass through the flow channel to the auxiliary chamber when the rod is moved in a direction towards the stop position so that at least the gaseous fluid exerts a second force on a surface of the rod, opposite the lower surface of the rod, that acts against the first force. A closure element coupled to a portion of the body base is also provided and adapted to close the flow channel in the rod when the rod is in the stop position.

### TECHNICAL FIELD

The present invention relates to gas cylinders, generally used in forming material and of the controlled-stop type, so that the movement of a rod of said cylinders to its original position may be controlled without it affecting the piece being produced.

### PRIOR ART

Gas cylinders comprise a cylinder body and a rod that moves axially inside said body when a force or pressure is exerted on it, for example, during a material forming process in which a piece is obtained by means of at least one blow. An upper die or punch, for example, may strike against a lower die or mould, underneath which are disposed the gas cylinders, the rod of which is displaced when said lower die suffers the blow exerted by the upper die.

Gas cylinders also comprise a gas chamber, said gas being compressed when the rod moves as a result of the effect of the pressure exerted on it, or said gas being decompressed when said pressure is no longer exerted and the rod returns to its original position.

Gas cylinders are known in which, when the rod no longer has a pressure or force exerted on it, the gas in the cylinder chamber is decompressed, thus causing a new movement of the rod in the opposite direction, the result being that it returns to its original position. This may cause serious problems in the piece obtained during the material forming process, with the possibility that it may be deformed if the rod hits it when it is returning to its original position, for example.

Gas cylinders with a controlled-stop are also known, so that the moment at which the rod returns to its original position may be controlled, thereby preventing the deformation of the piece obtained by said rod. ES2216673A1, for example, discloses a cylinder of this type. Said gas cylinder comprises two main chambers and an accumulator with a chamber that is communicated with the two main chambers by means of two ducts, it being possible to adjust the pressure compensation between the chambers in order to control the movement of the rod of the cylinder. Each duct comprises an electric valve that changes the pressures of the chambers, the result being that by opening or closing said electric valves the rod of the cylinder may or may not be allowed to return to its original position. When installing said gas cylinder sufficient space must be left in order to dispose the body of the cylinder, the accumulator, the electric valves and the ducts, something that is often complicated and which also makes said installation complex.

### DISCLOSURE OF THE INVENTION

It is the object of the invention to provide a controlled-stop gas cylinder that solves at least some of the drawbacks of the prior art.

The gas cylinder of the invention comprises a hollow cylindrical body, a body base fixed to a first end of the body, and a rod that is axially movable inside the body from a rest position to a stop position and vice versa. Said cylinder also comprises a main chamber that comprises in its interior at least one pressurised fluid when said rod is in the rest position, said fluid exerting a pressure on said rod in order to keep it in the rest position, an auxiliary chamber independent to the first chamber, and a flow duct that connects both chambers, the fluid of the main chamber being able to pass to the auxiliary chamber through said flow duct when the rod moves towards the stop position, and said flow duct being disposed inside said rod. When the rod is in the stop position the fluid present in the auxiliary chamber exerts a pressure on said rod in order to keep it in said stop position, against the pressure the fluid of the main chamber exerts on said rod.

The cylinder also comprises closure means linked to the body base and designed to close the flow duct when the rod reaches the stop position, thereby preventing the communication between the main chamber and the auxiliary chamber, and, therefore, preventing the passage of fluid from one chamber to the other. When the flow duct is closed, said closure means also cause an increase in the volume of the main chamber, causing the fluid present in said main chamber to expand.

The main chamber comprises a gaseous fluid and an oily fluid in its interior when the rod is in the rest position, only comprising oily fluid when said rod is in the stop position.

The compression property of an oily fluid is lower than that of a gaseous fluid, which means that when the volume of the main chamber increases when the rod is in the stop position, and the oily fluid present in said main chamber expands, the pressure of said oily fluid is lower than that of the gaseous fluid of the auxiliary chamber, thereby preventing any movement of the rod to the rest position that may cause damage to a piece, when the flow duct is closed, the stopping of the rod of the cylinder being controlled. Thus, the stopping of said rod may be controlled without the need to add an external accumulator to the cylinder of the invention, thus making the cylinder easier to install.

These and other advantages and characteristics of the invention will be made evident in the light of the drawings and the detailed description thereof.

### DESCRIPTION OF THE DRAWINGS

FIG. 1 is a sectional view of an embodiment of the cylinder of the invention, with the rod in a rest position.

FIG. 2 is a sectional view of the cylinder of FIG. 1, with the rod in a stop position.

### DETAILED DISCLOSURE OF THE INVENTION

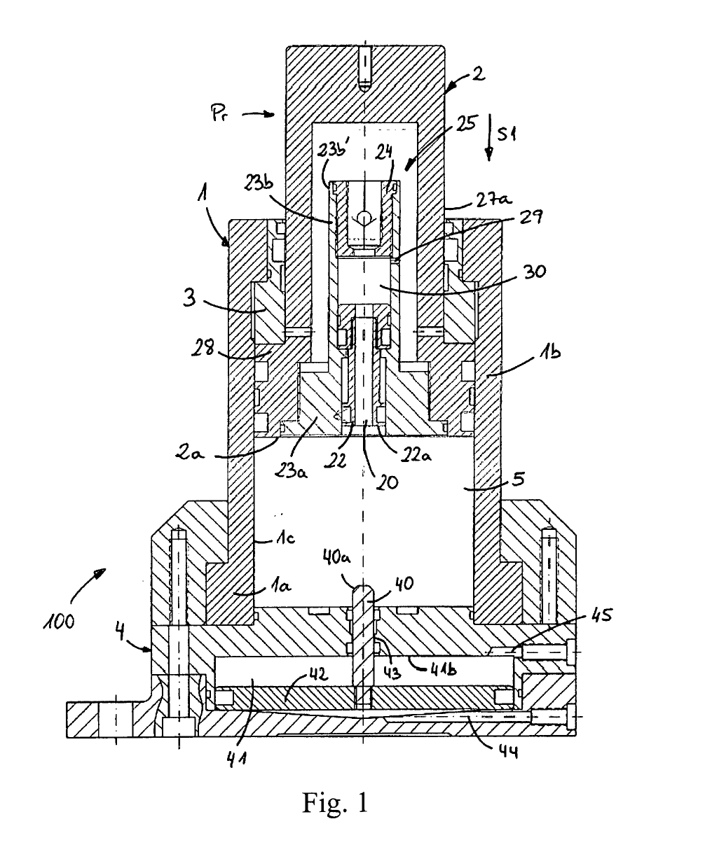

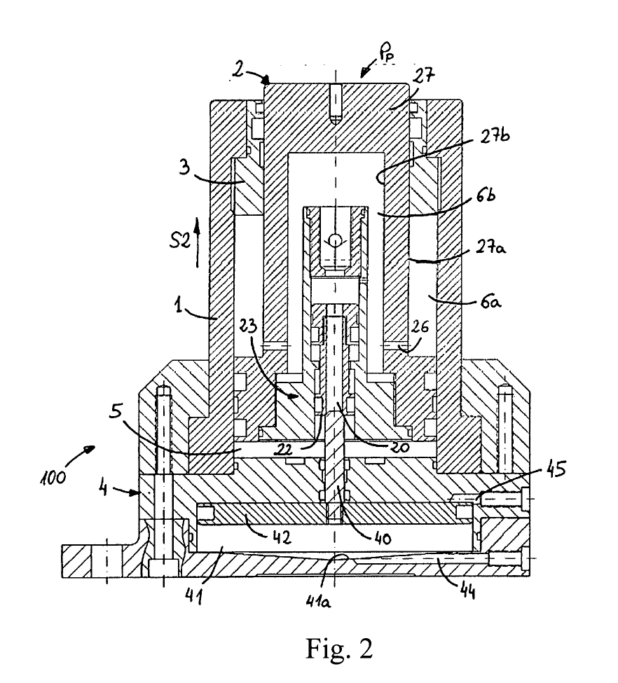

FIGS. 1 and 2 show an embodiment of the gas cylinder 100 of the invention. The cylinder 100 comprises a hollow cylinder body 1, preferably cylindrical, a body base 4 fixed to a first end 1a of the cylinder body 1, although it may also form part of said cylinder body 1, and a rod 2 that is axially movable inside the cylinder body 1 from a rest position Pr shown in FIG. 1 to a stop position Pp shown in FIG. 2, towards the body base 4 in a stop direction S1, or from the stop position Pp to the rest position Pr in a release direction S2, and which comprises an axial rod body 27 and a ring-shaped rod base 28 fixed to one end of said rod body 27. The cylinder 100 also comprises a main chamber 5 inside the cylinder body 1, which comprises at least one pressurised fluid in its interior when said rod 2 is in the rest position Pr, an auxiliary chamber 6a, 6b independent to the main chamber 5, and a flow duct 20 that is disposed inside the rod 2 and which communicates the main chamber 5 with the auxiliary chamber 6a, 6b, the fluid of the main chamber 5 being able to pass to the auxiliary chamber 6a, 6b when the rod 2 moves towards the stop position Pp through said flow duct 20, or vice versa. The fluid of the main chamber 5 exerts a release force in the release direction S2 on the rod 2, while the fluid of the auxiliary chamber 6a, 6b exerts a stopping force in the stop direction S1 on said rod 2. When the rod 2 is in the stop position Pp, the release force and the stopping force are balanced, said rod 2 remaining static. When the rod 2 is in the rest position Pr, the release force is greater than the stopping force, it being necessary to apply an external force in the stop direction S1 greater than said release force in order to move said rod 2 in the stop direction S1 towards the stop position Pp.

When the rod is in the rest position Pr, stopper means 3 disposed in a second end 1b of the cylinder body 1, opposite to the first end 1a, prevent the rod 2 from coming out of said cylinder body 1, thereby limiting its movement in the release direction S2. The stopper means 3 may be, for example, a retainer bushing, such as the one shown in the figures, which is fixed to the second end 1b inside the cylinder body 1, or alternatively the cylinder body 1 itself may comprise a shape similar to that of the retainer bushing on said second end 1b.

The main chamber 5 comprises a pressurised gaseous fluid and a pressurised oily fluid in its interior when the rod 2 is in the rest position Pr, the volume of the oily fluid being greater or substantially the same as the total volume of the main chamber 5 when the rod 2 is in the stop position Pp. Due to the properties of both fluids, when the rod 2 moves in the stop direction S1 the first fluid that passes to the auxiliary chamber 6a, 6b through the flow duct 20 is the gaseous fluid, so that when said rod 2 reaches the stop position Pp, only the oily fluid is present in the main chamber 5, the gaseous fluid being in the auxiliary chamber 6a, 6b. The cylinder 100 also comprises closure means linked to the body base 4, which are designed to close the flow duct 20 when the rod 2 reaches the stop position Pp, thereby preventing the passage of a fluid from one chamber to the other. In addition, when the closure means close said flow duct 20 they cause an increase in volume in the main chamber 5, the fluid present in said main chamber 5, the oily fluid, being expanded until the new volume is filled, losing at least part of its pressure. Thus, the stopping force that the fluid of the auxiliary chamber 6a, 6b exerts on the rod 2 in the stop direction S1 may equal or exceed the release force exerted by the fluid of the main chamber 5 on said rod 2 in the release direction S2, thereby preventing any movement or rebounding of said rod in the release direction S2. If the stopping force is equal to the release force, the rod 2 remains in the stop position Pp, if said stopping force exceeds said release force, said rod 2 moves in the stop direction S1, thereby compressing the oily fluid of the main chamber 5, until both forces are equal.

The rod 2 comprises an internal housing 25, a closure piece 22 linked with freedom of axial movement to said rod 2 housed in the housing 25, it being capable of moving axially in said housing 25 in relation to said rod 2. The closure piece 22 extends axially and is hollow, the cavity forming the flow duct 20. Thus, in order to close said flow duct 20, the closure means come into contact with the closure piece 22 to close the cavity of said closure piece 22 and cause, at the same time, an axial movement of said closure piece 22 in relation to the rod 2 in the release direction S2. The main chamber 5 is disposed between the rod 2 and the body base 4, being delimited by an internal surface 1c of the cylinder body 1, a lower surface 2a of the rod 2 and an upper surface 4a of the body base 4. A base 22a of said closure piece 22 forms part of the lower surface 2a of the rod 2, so that when said closure piece 22 moves axially in the release direction S2, the volume of said main chamber 5 increases.

The closure piece 22 does not occupy all the housing 25 of the rod 2, leaving a hollow space 6b in said housing 25 communicated with the flow duct 20, where fluid originating from the main chamber 5 may be disposed. In addition, there is a separation gap 6a between the internal surface 1c of the cylinder body 1 and an external surface 27a of the rod body 27, said separation gap 6a also being delimited by the stopper means 3 and the rod base 28. The rod 2 comprises at least one connection passage 26 between the hollow space 6b of the housing 25 and the separation gap 6a, said hollow space 6b and said separation gap 6a forming the auxiliary chamber 6a, 6b.

The closure means comprise a closure shaft 40 that is disposed at least partially in the main chamber 5, linked to the body base 4, and which comprises a diameter greater than the diameter of the flow duct 20, covering or closing said flow duct 20 when the rod 2 reaches the stop position Pp. In order to ensure the closure of the flow duct 20, said closure shaft 40 may also comprise a beveled edge 40a, so that said bevelled edge 40a may be inserted at least partially in said flow duct 20 in order to close it, although it may also comprise elastic means, for example, in order to ensure said closure, instead of a beveled edge 40a.

The cylinder 100 comprises displacement means linked to the body base 4, which cause the axial movement of the closure shaft 40 when said rod 2 reaches the stop position Pp, so that when it comes into contact with the flow duct 20, it closes it and causes an axial movement of the closure piece 22. The volume by which the main chamber 5 increases depends therefore on how much said closure piece 22 moves axially, which depends on the requirements of the cylinder 100 during its design. The displacement means comprise a cavity 41 disposed in the body base 4, a displacement support 42 housed in the cavity 41 and an axial displacement hole 43 that connects said cavity 41 to the main chamber 5, thereby causing the axial movement of the displacement support 42 in said cavity 41 towards the rod 2, when said rod 2 reaches the stop position Pp. The closure shaft 40 is fixed to the displacement support 42 and housed in the displacement hole 43, moving in conjunction with said displacement support 42, closing the flow duct 20 and pushing the closure piece 22.

The body base 4 comprises a closure hole 44 connected to a lower surface 41a of the cavity 41, so that when a fluid is introduced in said cavity 41 through said closure hole 44, said fluid acts against the displacement support 42 causing an axial movement of said displacement support 42 towards the rod 2. Said body base 4 also comprises a return hole 45 connected to an upper surface 41b of the cavity 41, so that when a fluid is introduced in said cavity 41 through said return hole 45, said fluid acts against the displacement support 42 causing an axial movement of said displacement support 42, moving away from the rod 2. When a fluid is introduced in the closure hole 44, the fluid present in the cavity 41 on the displacement support 42 may come out of said cavity 41 through the return hole 45 or through another hole specifically for said function, not shown in the figures, said displacement support 42 being capable of moving in order to close the flow duct 20. Similarly, when a fluid is introduced in the return hole 45, the fluid present in the cavity 41 beneath the displacement support 42 may come out of said cavity 41 through the closure hole 44 or through another hole specifically for said function, not shown in the figures, said displacement support 42 being capable of moving in order to release the flow duct 20. The fluid that is introduced in the holes 44 and 45 is preferably air, the displacement support 42 and the closure shaft 40 acting like a pneumatic cylinder.

The cylinder 100 may also comprise conventional anti-return means 24, which comprise a duct to enable the passage of fluid from the main chamber 5 to the auxiliary chamber 6a, 6b but not in the opposite direction, the aim being that once the flow duct 20 is released from the closure shaft 40, said rod 2 does not suddenly return to the rest position Pr. However, to ensure that said rod 2 may move to said rest position Pr it is necessary that the fluid of the auxiliary chamber 6a, 6b passes to the main chamber 5. To ensure this, the cylinder 100 comprises a choke hole that connects the flow duct 20 to the auxiliary chamber 6a, 6b, the fluid of said auxiliary chamber 6a, 6b passing to the main chamber 5 through the choke hole 29, which comprises a diameter that is substantially smaller than the diameter of the duct of the anti-return means 24. Preferably, the cylinder 100 also comprises a hollow support piece 23 disposed in the housing 25 of the rod 2, which comprises the choke hole 29 and which is fixed without freedom of movement to said rod 2, the anti-return means 24 and the closure piece 22 being housed in its interior. The support piece 23 comprises a transverse base member 23a and an axial extension 23b that extends axially from the transverse base member 23a, said support piece 23 preferably being fixed to the rod 2 by the transverse base member 23a and the housing 25 comprising the hollow space 6b between an external surface 23b′ of said axial extension 23b and an internal surface 27b of the rod body 27. The closure piece 22 is housed in the end of the support piece 23 facing the main chamber 5, it being capable of moving axially, while the anti-return means 24 are fixed on the opposite end, without freedom of movement. Between said anti-return means 24 and said closure piece 22 the support piece 23 comprises a gap 30 connected to the hollow space 6b through the choke hole 29.

When the rod 2 moves in the stop direction S1, the fluid of the main chamber 5 passes to the auxiliary chamber 6a, 6b through the flow duct 20, the gap 30 and mainly anti-return means 24, although part of the fluid also passes through the choke hole 29. When the rod 2 moves in the release direction S2, however, the fluid of the auxiliary chamber 6a, 6b passes to the main chamber 5 through the choke hole 29, the gap 30 and the flow duct 20, and does not pass through the anti-return means. As the diameter of said choke hole 29 is very small, the passage of the fluid from said auxiliary chamber 6a, 6b to said main chamber 5 is slow, said rod 2 not moving to the rest position Pr suddenly.

Instead of a support piece 23, the cylinder may comprise anti-return means 24 fixed to the closure piece 22, moving in conjunction with said closure piece 22, said closure piece 22 or said anti-return means comprising the choke hole 29.

1-12. (canceled)

13. A cylinder comprising:
a hollow cylinder body having at one end a body base,
a rod axially moveable within the hollow cylindrical body between a rest position and a stop position, the rod having a lower surface and a flow channel extending axially from a location at or adjacent the lower surface in a direction toward an upper surface of the rod,
a main chamber located within the hollow cylindrical body between the lower surface of the rod and an upper surface of the body base, the main chamber adapted to contain a fluid comprising a gaseous fluid and an oily fluid when the rod is in the rest position so that the fluid exerts a first force on the lower surface of the rod to urge the rod toward the rest position, the main chamber predominately containing only the oily fluid when the rod is in the stop position,
an auxiliary chamber in flow communication with the main chamber via the flow channel when the rod is not in the stop position, the auxiliary chamber, main chamber and flow channel configured to cause at least the gaseous fluid to be located in the main chamber to pass through the flow channel to the auxiliary chamber when the rod is moved in a direction towards the stop position so that at least the gaseous fluid exerts a second force on a surface of the rod, opposite the lower surface of the rod, that acts against the first force,
a closure element coupled to a portion of the body base and adapted to close the flow channel in the rod when the rod is in the stop position.

14. A cylinder according to claim 13, wherein the rod comprises a closure piece that is at least partially disposed within a housing of the rod and which is axially moveable in the housing in relation to the rod, the closure piece comprising the flow channel, the closure element adapted to engage with the closure piece to cause an axial movement between the rod and the closure piece as the rod approaches the stop position.

15. A cylinder according to claim 14, wherein the closure element is at least partially disposed in the main chamber and comprises an axial closure shaft that has a distal segment with a larger cross-sectional area than the flow channel with the result that when the rod approaches the stop position, the closure piece and the closure shaft come into contact.

16. A cylinder according to claim 13, wherein the portion of the base to which the closure element is coupled is moveable between a first axial position and a second axial position to cause an axial movement of the closure element.

17. A cylinder according to claim 16, wherein the moveable portion of the body base is located within a cavity of the body base.

18. A cylinder according to claim 17, wherein the body base comprises a first hole connected to a lower surface of the cavity, so that when a third fluid is introduced into cavity through the first hole, the third fluid acts against the moveable portion, causing an axial movement of the moveable portion in a direction towards the rod.

19. A cylinder according to claim 18, wherein the body base comprises a second hole connected to an upper surface of the cavity, so that when the third fluid is introduced into said cavity through the second hole, the third fluid acts against the moveable portion, causing an axial movement of the moveable portion away from the rod.

20. A cylinder according to claim 15, wherein the closure shaft comprises a beveled edge at a distal end thereof, with the result that when the closure piece and the closure shaft come into contact, the beveled edge is inserted in the flow channel, thereby closing it.

21. A cylinder according to claim 14, further comprising an anti-return element coupled to the closure piece, the anti-return element having a duct in fluid communication with the flow channel, the duct of the anti-return allowing the passage of fluid only in a direction from the flow channel toward the auxiliary chamber.

22. A cylinder according to claim 21, wherein the closure piece further comprises a choke hole that connects the flow channel to the auxiliary chamber to permit a fluid in the auxiliary chamber to pass to the main chamber through the choke hole.

23. A cylinder according to claim 21, wherein the anti-return element comprises a choke hole that connects the flow channel to the auxiliary chamber to permit a fluid in the auxiliary chamber to pass to the main chamber through the choke hole.

24. A cylinder according to claim 21, wherein the closure piece comprises a gap positioned between the anti-return element and the flow channel out, the choke hole located within the gap and connecting the gap with the auxiliary chamber.

25. A cylinder according to claim 22, wherein the cross-sectional area of the choke hole is smaller than the cross-sectional area of the duct of the anti-return element.

26. A cylinder according to claim 21, wherein the cross-sectional area of the choke hole is smaller than the cross-sectional area of the duct of the anti-return element.
